(19) United States
(12) Patent Application Publication
(10) Pub. No.: US 2025/0368111 A1
(43) Pub. Date: Dec. 4, 2025

(54) PADDING SYSTEM AND METHOD OF MANUFACTURING SUCH A SYSTEM

(71) Applicants: FAURECIA Sièges d'Automobile, NANTERRE (FR); Indorama Ventures Mobility Obernburg GmbH, Obernburg (DE)

(72) Inventors: Mathieu CLUET, ETAMPES (FR); Benoît GAZANIOL, ARPAJON (FR); Mathieu BOQUET, VERRIERES LE BUISSON (FR)

(21) Appl. No.: 19/219,199

(22) Filed: May 27, 2025

(30) Foreign Application Priority Data
May 28, 2024 (FR) 2405498

(51) Int. Cl. B60N 2/72; B60N 2/70

(52) U.S. Cl. CPC B60N 2/72; B60N 2/7017

(57) ABSTRACT

A padding system comprising a padding comprising a groove on a surface of the padding intended to receive an occupant, a hole extending along an axis and traversing the padding from a bottom wall of the groove, a fastening device integral to the padding, configured to provide the attachment of a cover to the padding, the fastening device comprising: a fastening part comprising a portion configured to allow attaching the cover, the fastening part being retained so as to project into the groove, a base part extending under the fastening part into the hole, at least one attachment part connected to the base part, comprising a rod traversing the padding at a distance from the hole and a stop collar projecting from the bottom wall of the groove, the stop collar being obtained by an operation of melting material from a free end of the rod.

### PRIORITY CLAIM

This application claims priority under 35 U.S.C. §119(e) to French Patent Application FR2405498, filed May 28, 2024, which is expressly incorporated by reference herein.

### BACKGROUND

The present disclosure relates to the field of fastening devices configured to attach a cover to padding, in particular padding for seats, preferably vehicle seats. The present disclosure concerns a padding system comprising padding and a fastening device attached to the padding, configured to provide the retention of a cover on the padding, as well as a method of manufacturing such a padding system

### SUMMARY

According to the present disclosure, a padding system is proposed comprising:

a padding comprising a groove on a surface of the padding intended to receive an occupant, a hole extending along an axis and traversing the padding from a bottom wall of the groove,

a fastening device integral to the padding, configured to provide the attachment of a cover to the padding, the fastening device comprising:

a fastening part, in particular a clip-on part, comprising a portion, in particular an elastically deformable portion, configured to allow attaching the cover, the fastening part being retained so as to project into the groove,

a base part extending under the fastening part into the hole,

at least one attachment part connected to the base part, comprising a rod traversing the padding at a distance from the hole and a stop collar projecting from the bottom wall of the groove, the stop collar being obtained by an operation of melting material from a free end of the rod.

The fastening device is thus inserted into the padding before the melting operation is performed, such that the padding system comprises a fastening device made integral to the padding by means of the abutment formed by the collar of the attachment part.

The features set forth in the following paragraphs may optionally be implemented, independently of one another or in combination with one another:

The stop collar may be welded to the padding. In this case, the melting operation includes a welding operation. The stop collar is then thus obtained by melting material from a free end of the rod, causing the stop collar to be welded to the bottom wall of the groove in the padding.

Alternatively, the stop collar is not welded to the padding, the melting operation having been carried out solely in order to create the stop collar in abutment against the bottom wall of the groove. In this case, the stop collar only forms a retaining element which functions via the abutment.

The stop collar is, for example, obtained by ultrasonic fusion. In this case, the melting operation consists of using at least one sonotrode and an anvil to melt the end of the rod in order to obtain the stop collar, while holding the fastening device in place in the padding.

The rod preferably extends substantially perpendicularly to the bottom wall of the groove. It passes through all or part of the thickness of the padding.

In some examples, the rod has a cylindrical shape. The cylindrical rod is preferably hollow, at least at the free end of the rod.

In other examples, the rod has a blade shape. In this case, the padding preferably comprises a through-slot, the blade extending into the slot.

The blade may extend transversely to an axis of the groove, in particular perpendicularly to it.

Alternatively, the blade may extend along the axis of the groove.

Regardless of its shape, the rod may act as a stabilizer for the fastening device in a positioning that allows for easy attachment of the cover, in particular clipping it on. In particular, when there are several fastening devices, they are preferably aligned along the longitudinal axis of the groove so as to facilitate attaching the cover.

The fastening device may comprise two attachment parts extending one on either side of the hole, preferably symmetrically to each other, in particular with an alignment between the rods and the hole along the axis of the groove.

The hole may comprise a first passage section in an upper first portion of the hole, and at least one second passage section, as an extension along the axis of the hole, in a lower second portion of the hole. The at least one second passage section may be wider than the first passage section, forming at least one shoulder between the upper first portion and the lower second portion of the hole. In this case, the fastening device may extend essentially at the upper first portion of the hole.

The fastening device may comprise at least one connecting part configured to connect the base portion and the at least one attachment part. In the case where the hole comprises a first and a second passage section, then the connecting part may extend into the second passage section, in particular at the shoulder.

The padding may comprise a 3d entanglement of continuous thermoplastic fibers arranged irregularly to form loops which are welded together. In this case, the groove and the hole may be formed in the 3d entanglement of fibers. In the case where the rod forms a blade, then the slot made in the padding is preferably formed in the 3d entanglement of fibers.

This thus provides padding made of a material other than polyurethane foam. This padding material is advantageously a recyclable plastic and its production generates fewer CO₂ emissions than the production of polyurethane foam, thus reducing the ecological impact of the seating element comprising this padding. In addition to the environmental benefits, the padding may be significantly lighter than similar polyurethane foam upholstery. Furthermore, the padding material may be more breathable, allowing better passage of air and any moisture through the padding.

The material of the padding and the material of the fastening device may be the same material, or two different materials with similar physicochemical properties, in particular the same chemical composition. This may allow the padding and the fastening device to be recycled simultaneously without separating them. Alternatively, the material of the padding and the material of the fastening device may be incompatible materials. In such case, solutions may be implemented to separate the incompatible materials for recycling purposes.

In some examples, the material of the padding and the material of the fastening device may be a thermoplastic polymer in which the main-chain repeating unit comprises the ester functional group and optionally the ether functional group, in particular a thermoplastic elastomer in which the main-chain repeating unit comprises the ester functional group and optionally the ether functional group.

According to another aspect, in combination with all or part of the above, a vehicle seat assembly is provided that comprises a padding system as defined above and a cover which covers all or part of the padding and is fixed to the padding by a fastening element, in particular a clip-on element, which interlocks, in particular elastically, with the fastening part of the fastening device.

According to another aspect, in combination with all or part of the above, a method of manufacturing a padding system as defined above is provided, comprising the following:

/A/ supplying a padding comprising a groove on a surface of the padding intended to receive an occupant, a hole extending along an axis (A) and traversing the padding from a bottom wall of the groove,

/B/ supplying a fastening device comprising:

a fastening part, in particular a clip-on part, comprising a portion, in particular an elastically deformable portion, configured to allow attaching the cover,

a base part extending under the fastening part,

at least one attachment part connected to the base part, comprising a rod which extends at a distance from the base part,

/C/ inserting the fastening device into the hole so that the fastening part is in position in the groove, projecting from the bottom wall of the groove with the base part extending into the hole, the rod traversing the padding at a distance from the hole, the free end of the rod projecting from the bottom wall of the groove,

/D/ melting material from a free end of the rod so as to create the stop collar projecting from the bottom wall of the groove.

Supplying the padding may comprise obtaining the padding by extruding a 3d entanglement of continuous thermoplastic fibers arranged irregularly to form loops which are welded together, and shaping the 3d entanglement by thermoforming in order to obtain the groove and the hole.

According to another aspect, in combination with all or part of the above, a method of recycling a vehicle seat assembly as defined above is provided, the material of the padding and of the fastening device being a thermoplastic polymer in which the main-chain repeating unit comprises the ester functional group and optionally the ether functional group, the method comprising:

optionally, separating the cover from the padding system,

grinding the padding and the fastening device attached to the padding, to produce granules,

using the granules to manufacture a plastic product based on a thermoplastic polymer in which the main-chain repeating unit comprises the ester functional group and optionally the ether functional group, in particular by molding or extrusion.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic and perspective top view of an exemplary padding system.

FIG. 2 is a schematic and perspective bottom view of an exemplary padding system.

FIG. 3 is an enlarged, schematic and perspective top view of the fastening device of an exemplary padding system.

FIG. 4 is an isolated, schematic and perspective side view of the fastening device of an exemplary padding system.

FIG. 5 is a section view along a plane including the axis of the groove of an exemplary padding system.

FIG. 6 is a section view similar to the view of FIG. 5, illustrating the implementation of part of the method according to one example.

FIG. 7 is a view similar to FIG. 3 of another example of a fastening device.

FIG. 8 is a view similar to FIG. 3 of another example of a fastening device.

FIG. 9 schematically shows a perspective side view of one example of a seat element.

FIG. 10 schematically shows a perspective view of one example of a facility for implementing at least part of one example of the method.

### DETAILED DESCRIPTION

In the various figures, the same references designate identical or similar elements. For the sake of brevity, only those elements that are useful to understanding the described embodiment are shown in the figures and are described in detail below.

In the following description, when reference is made to absolute position qualifiers, such as the terms “front”, “rear”, “top”, “bottom”, “left”, “right”, etc., or relative position qualifiers, such as the terms “above”, “below”, “upper”, “lower”, etc., or to orientation qualifiers, such as “horizontal”, “vertical”, etc., these refer, unless otherwise specified, to the orientation in the figures or to the orientation of a vehicle seat element or vehicle seat in its normal position of use.

Reference is now made to FIG. 1 which represents a padding system 1 comprising padding 2 and a fastening device 3 that is integral with the padding and configured to allow attaching a cover over padding 2, preferably taut over the padding. A single fastening device 3 is shown in the figure but padding system 1 may comprise several.

The padding may comprise a 3d entanglement of continuous thermoplastic fibers arranged irregularly to form loops which are welded together, and to which fastening device 3 is attached. Generally, the fibers of the 3d entanglement, for example, polyester-based, may be hollow fibers and/or solid fibers. The fibers may have a diameter between 0.2 mm and 2 mm, preferably between 0.3 mm and 1.5 mm. The term “continuous” in “continuous fibers” means that the fibers have a much greater length than their diameter, and, due to the method of manufacturing which is described below, for example, at least by a ratio of 100, or even 500, or even 1000.

The 3D entanglement of continuous fibers may have an apparent density of between 20 kg/m3 and 70 kg/m3, in particular between 45 kg/m3 and 60 kg/m3, preferably between 35 and 70 kg/m3.

Very often, and in particular as is understandable from the method of manufacturing by extrusion which will be described below, the fibers, for example, extend from a first end at a first edge of the 3D entanglement and to a second end at a second edge of the 3D entanglement, opposite the first edge.

The fibers of the padding may comprise a thermoplastic polymer, the composition of the fibers preferably comprising at least 95% by weight of polyester. For example, the composition of the fibers, indeed of the padding, comprises 95% to 99% by weight of a first polymer in the polyester family, such as PBT (Polybutylene terephthalate), and 1% to 5% by weight of a second polymer in the polyester family, such as PTT (Polytrimethylene terephthalate) or another polymer of the polyester family. The sum of PBT and PTT (or other) may be 100% by weight of the fibers, indeed of the padding.

Preferably, the voids between the fibers of the 3D entanglement of padding fibers are left empty. This produces a highly breathable padding, due to the numerous spaces between the fibers which facilitate air circulation, as opposed to a molded polyurethane body, which is close to a body that comparatively is not permeable to air.

The padding may be, without limitation, a seat padding, in particular a seating portion padding, or a backrest padding, an armrest padding, or any other seat padding.

Padding 2 comprises a groove 4 into its depth, extending in this example along a longitudinal axis X on a surface 5 of the padding intended to receive an occupant.

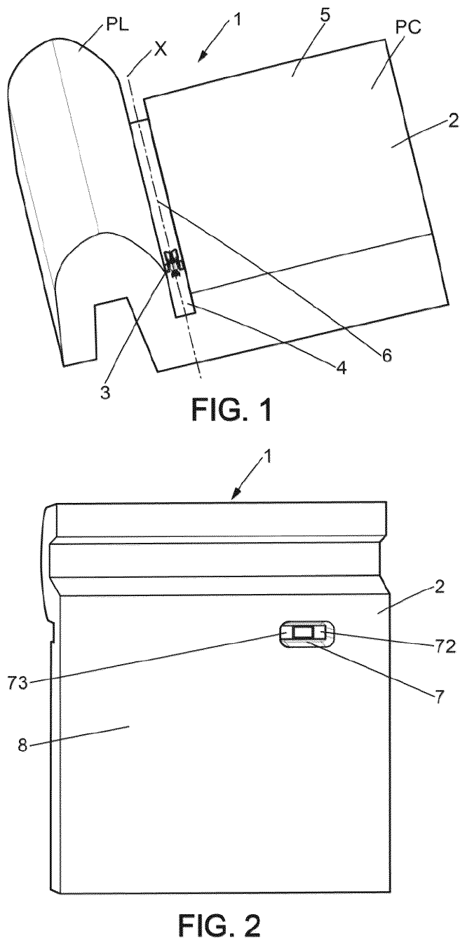

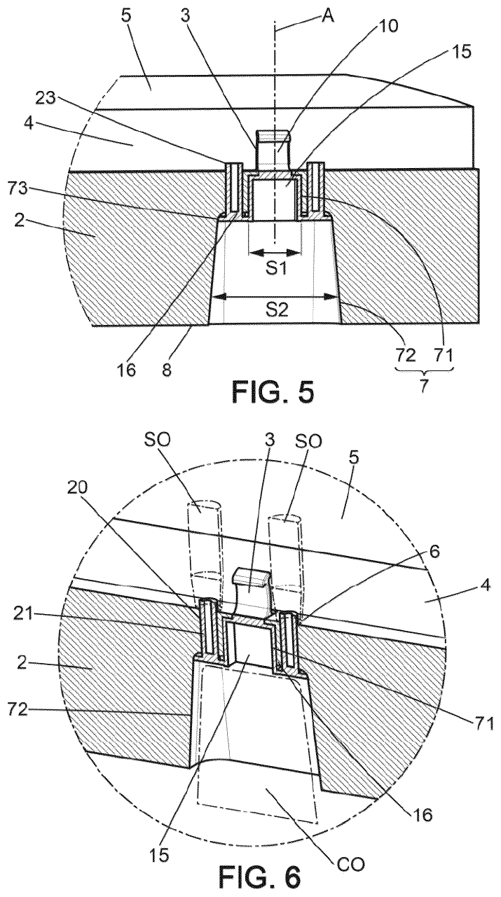

Padding 2 also comprises a hole 7, more visible in FIG. 2 and FIG. 5, extending along an axis A and traversing padding 2 from a bottom wall 6 of groove 4. Hole 7 in this example is a through-hole extending from a mouth in bottom wall 6 of the groove to a mouth on the side 8 of the padding that is opposite to groove 4. Hole 7 comprises a first passage section S1, in an upper first portion 71 of hole 7 along axis A, and at least one second passage section S2, as an extension along axis A, in a lower second portion 72 of the hole.

The length of first portion 71 of hole 7 along axis A may be less than or equal to the length of second portion 72 of hole 7 along axis A.

In the example illustrated, second passage section S2 is wider than first passage section S1, forming at least one shoulder 73 between first portion 71 and second portion 72 of hole 7. The passage section of the hole is understood to mean the section as viewed in a plane perpendicular to axis A. Shoulder 73 is formed due to the difference in cross-section between first section S1 and second section S2.

In this example, padding 2 has a surface 5 which is partially flat, on one side of groove 4, and curved in a projecting relief on the other side of the groove, as can be seen in FIG. 1. The relief of surface 5 may differ from this without departing from the scope of the present disclosure.

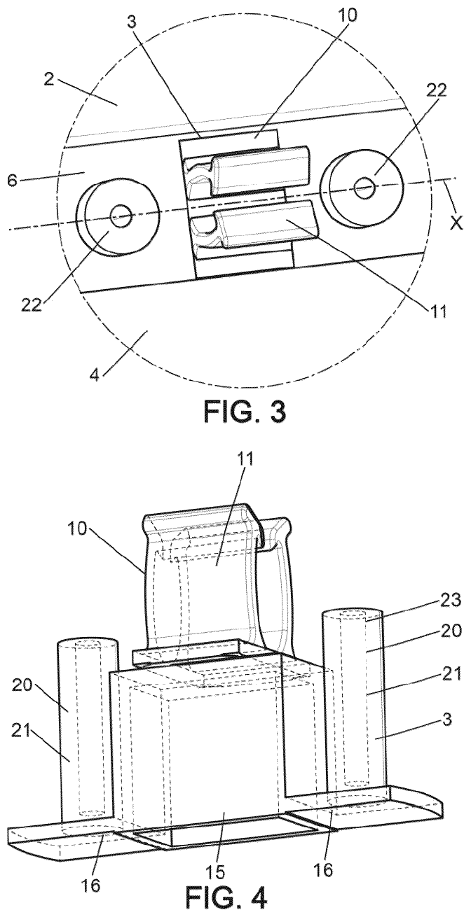

Fastening device 3 comprises, as is more visible in FIGS. 3 and 4, a fastening part 10, in this example a clip-on part, comprising a portion 11, in this example elastically deformable, configured to allow attaching the cover. Fastening part 10 is retained so that it projects into groove 4. Portion 11, elastically deformable in this example, comprises two elastic tabs, each comprising a curved part extending above bottom wall 6 of the groove so that together they form a portion of a circle, then, at the free end of fastening part 10, two plates which are elongate along the longitudinal axis of groove 4 and are inclined towards the inside of the circle. Other shapes for fastening part 10 are conceivable, its role being to allow hooking on the cover in the context of a seat.

Fastening device 3 also comprises a base part 15 extending under fastening part 10 into hole 7. In the example illustrated, base part 15 forms a support base to support fastening part 10. In this example, base part 15 forms a hollow parallelepiped which is open at its base, extending essentially into first portion 71 of hole 7 and its lower end extending into second portion 72 of hole 7.

Fastening device 3 further comprises at least one attachment part 20 connected to base part 15, in the illustrated example two attachment parts 20 one on either side of base part 15, in that example along longitudinal axis X. Each attachment part 20 comprises a rod 21 traversing padding 2 at a distance from hole 7, and a stop collar 22 projecting from bottom wall 6 of groove 4. “At a distance from the hole” is understood to mean a non-zero distance, the or each rod 21 not extending into hole 7. In this example, rods 21 are arranged equidistant from fastening part 10, symmetrically on either side thereof, on longitudinal axis X.

Each stop collar 22 is obtained by melting material from a free end 23 of rod 21. Stop collar 22 has a diameter greater than that of rod 21, in particular end 23 of rod 21 which has been melted. Stop collar 22, created by melting, forms an extended fixing surface and provides the alignment of fastening device 3, i.e. its absence of rotation. FIG. 4 illustrates fastening device 3 before insertion into the padding and before the melting operation. FIG. 3 illustrates fastening device 3 in place in padding 2 after the melting operation has formed the one or more, in this example two, stop collars 22.

The two attachment parts 20 extend one on either side of hole 7, in this example symmetrically to each other, in particular with an alignment between rods 21 and hole 7 along longitudinal axis X of groove 4.

In this example, fastening device 3 comprises at least one connecting part 16 configured to connect base part 15 and each attachment part 20, and extending second portion 72 of hole 7. In this example and as can be seen in FIG. 5, connecting part 16 comes to abut against shoulder 73, extending, with base part 15, along the entire extent of second passage section S2 at shoulder 73. It should be noted that each rod 21 extends above second portion 72 of the hole and next to first portion 71 of the hole, in this example parallel to axis A of hole 7. In the illustrated example, connecting part 16 extends perpendicularly to axis A of the hole, around base part 15.

In an example not illustrated, hole 7 has only one passage section from surface 5 to the opposite side 8. In such case, connecting part 16 can abut against side 8.

Fastening device 3 is held in abutment by stop collar 22 bearing against or being welded to surface 5 of padding 2, and a counter-stop is formed by connecting part 16 bearing against shoulder 73, or, in the absence of shoulder 73, against the opposite side 8 of padding 2. For example, a tear strength of 7 daN is desired.

In the example illustrated, stop collar 22 is welded to padding 2. In such case, stop collar 22 is welded, therefore fixed, to bottom wall 6 of the groove. In other examples, it is not welded, forming only a stop surface extending over bottom wall 6 of the groove but not fixed to wall 6.

Stop collar 22 may be obtained by ultrasonic fusion. In such a case, as illustrated in FIG. 6, the tool may comprise one or more sonotrode(s) SO and an anvil CO to hold fastening device 3 in place while performing the melting operation which may be an operation of welding stop collar 22 to padding 2 at bottom wall 6 of the groove. In the example illustrated, the two sonotrodes SO enter groove 4 to cover the ends of rods 21 while anvil CO is inserted into second passage section S2, extending in this example through all of second portion 72 of hole 7. In the case of welding, the materials of the padding and of the fastening device are compatible for welding. They may be made of the same thermoplastic polymer material. Alternatively, they may both constitute a polyester. Alternatively, they comprise plastic materials which are compatible for welding, the fastening device comprising, for example, ABS (polyacrylonitile/butadiene/styrene), PC (polycarbonate).

The melting operation that is carried out consists of melting solid material, in this case free end 23 of the rod, in order to bond, in the case of welding, to the padding and not the reverse.

Thus, as illustrated in FIG. 6 in particular, the method implemented for the manufacture of the padding system comprises supplying padding 2 comprising a groove 4 on a surface 5 of padding 2 intended to receive an occupant, a hole 7 extending along an axis A and traversing padding 2 from a bottom wall 6 of the groove. Also provided is fastening device 3 which is inserted into hole 7 so that fastening part 10 is in position in groove 4, projecting from bottom wall 6 of the groove, free end 23 of rod 21 projecting from bottom wall 6 of the groove. Then the operation of melting free end 23 of rod 21 is carried out in a manner that creates stop collar 22, projecting from bottom wall 6 of the groove.

In the example of FIGS. 1 to 6, rod 21 has a cylindrical shape. This cylindrical shape is hollow at least at free end 23 of rod 21, in this example along the entire height of rod 21 as can be seen in FIGS. 5 and 6. The hollow shape may allow faster melting during the melting operation that produces stop collar 22.

In the illustrated example where padding 2 comprises a 3d entanglement of continuous thermoplastic fibers arranged irregularly to form loops which are welded together, groove 4 and hole 7 are formed in the 3d entanglement of fibers.

The material of padding 2 and the material of fastening device 3 may be the same material, or two different materials having similar physicochemical properties, in particular the same chemical composition. In this case, the melting operation may result in welding stop collar 2 and bottom wall 6 of the groove with which it is in contact. This may make it possible to recycle the padding and the fastening device simultaneously without separating them. Alternatively, the material of the padding and the material of the fastening device may be incompatible materials. In this case, stop collar 22 may not be welded but may only bear against bottom wall 6 of the groove.

In some examples, the material of padding 2 and the material of fastening device 3 may be a thermoplastic polymer in which the main-chain repeating unit comprises the ester functional group and optionally the ether functional group, in particular a thermoplastic elastomer in which the main-chain repeating unit comprises the ester functional group and optionally the ether functional group.

In the example illustrated in FIGS. 1 to 6, rod 21, in this case each rod 21, forms a cylindrical rod. In this example, no orifice is previously formed, for example by thermoforming, in padding 2 in order to accommodate rod 21. Rod 21 therefore penetrates into padding 2, for example spreading apart the fibers of the 3d entanglement of fibers.

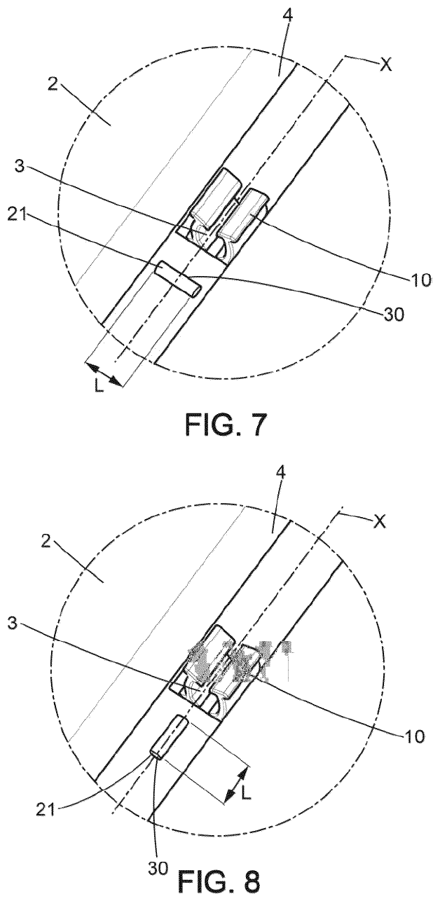

In the examples illustrated in FIGS. 7 and 8, rod 21 has a blade shape, as can be seen, i.e. a rod 21 having a smaller width than length in cross-section, the cross-sectional shape being rectangular in this example. In such case, padding 2 may comprise a through-slot 30, formed for example in the 3D entanglement of fibers, the blade extending into the slot.

In the example of FIG. 7, the blade extends transversely to axis X of the groove. This means that the length L of the blade, in cross-section, extends along an axis perpendicular to axis X of groove 4. Slot 30 is then also transverse to axis X of groove 4. The shape of stop collar 22 is substantially rectangular in this example. Still in the example of FIG. 7, as in that of FIG. 8, fastening device 3 comprises a single attachment device 20 which, given its shape, allows obtaining the desired aligned positioning of fastening device 3 in padding 2 for the attaching of the cover.

The example of FIG. 8 differs from FIG. 7 in that the blade forming rod 21 extends along axis X of groove 4.

The creation of a slot does not require the removal of material.

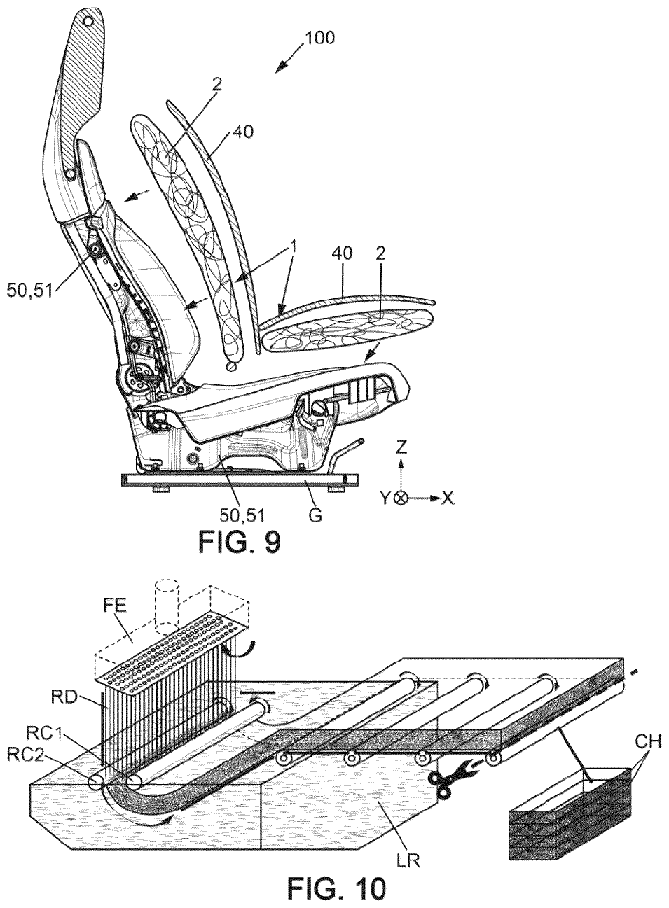

FIG. 9 shows one example of a vehicle seat assembly 100 comprising a padding system 1, and a cover 40 intended to cover all or part of padding 2 when it is fixed to padding 2 by a fastening element, in particular a clip-on element, which comes to interlock, in this example elastically, with fastening part 10 of fastening device 3. Several fastening devices 3 are preferably provided in padding 2 in order to engage, in particular by clipping, with several fastening elements, in particular clip-on elements, of cover 40.

Vehicle seat assembly 100 comprises a seating portion and a backrest forming a vehicle seat element 50 comprising a frame 51, or structure, in particular of metal, and padding 2.

In FIG. 9, an XYZ frame of reference is illustrated, the X direction oriented along the sliding direction of the track G between seat frame 51 and a floor of the vehicle, the Y direction oriented in a transverse direction of the seat, and the Z direction in the vertical direction. Frame 51 comprises a seating portion frame and a backrest frame, hinged on a transverse axis of rotation, for example by means of continuous type hinges.

The supplying of the padding may comprise, as illustrated in FIG. 10, obtaining the padding by extruding a 3d entanglement of continuous thermoplastic fibers arranged irregularly to form loops which are welded together, as well as shaping the 3d entanglement by thermoforming in order to obtain the groove and the hole.

The method comprises an extrusion of a thermoplastic polymer, in particular a thermoplastic polymer as defined above, in an extrusion die FE in a facility. Extrusion die FE may in particular be fed granules of thermoplastic polymer, in particular a thermoplastic polymer as defined above, for example from a recycling process.

Extrusion die FE comprises extrusion nozzles, distributed along a lengthwise direction and along a widthwise direction of the extrusion die. From the thermoplastic polymer, the extrusion die generates a curtain RD of continuous melted fibers which fall due to gravity. Curtain RD of continuous melted fibers then passes between two counter-rotating calender members RC1, RC2, for example in the form of rollers, generating a 3D entanglement of fibers in an irregular or random distribution, with fusion of loops between the continuous fibers and in a layer in which the total thickness is determined by the center-to-center distance between the two calender members RC1, RC2.

The two calender members RC1, RC2 are rotated at a speed that is, for example, lower than the speed at which the fibers are falling, ensuring an accumulation of the fibers which causes the formation of heat-welded loops between fibers, generating the irregular, random, three-dimensional entanglement.

Finally, the 3D entanglement of fibers is solidified by immersion in a cooling liquid LR to form a layer, which, after a possible cutting operation, allows the 3D entanglement of continuous fibers. Solidification is obtained immediately afterward, it being possible to half-immerse the two calender members in the cooling liquid for this purpose.

The layer of the 3D entanglement of fibers, which is advancing continuously, is then guided out of the tank of cooling liquid in order to be dried, for example, by shaking/vibration. The advancing layer is then cross-cut, which allows obtaining different first layers CH of padding 2, as can be seen in FIG. 10.

It is understood that the padding system may comprise a fastening device, or preferably several fastening devices, and in particular several fastening devices as described above, received in several holes, distributed in parallel along the length of a same groove.

When the padding is for a seating portion or a backrest, the padding, in particular the 3d entanglement of continuous fibers, may comprise a central portion (for example, called a center panel for the person skilled in the art), intended to receive the buttocks and/or thighs of the occupant of the seat in the case of seating portion padding, and at least one lateral portion PL, in particular a right lateral portion and a left lateral portion, for example, in the form of a side bolster that projects relative to central portion PC, the lateral portion configured to provide the lateral support of the occupant and raised relative to the central portion.

Groove 4 may extend along the length of the padding, deeper than central portion PC, all along the lateral portion, the groove being next to the lateral portion, with a view to stretching the cover over the central portion but also against the surface of the central portion of the padding.

When the material of padding 2 and of fastening device 3 is a thermoplastic polymer in which the main-chain repeating unit comprises the ester functional group and optionally the ether functional group, it is possible, at the end of the life cycle, to implement a recycling process comprising:
optionally, separating the cover from padding system 1,
grinding padding 2 and fastening device 3 attached to padding 2, to produce granules,
using the granules to manufacture a plastic product based on a thermoplastic polymer in which the main-chain repeating unit comprises the ester functional group and optionally the ether functional group, in particular by molding or extrusion.

In one example, comparative seat padding is substantially made from urethane polymer (polyurethane, PU) foam, particularly polyurethane foam obtained from polyether polyols (or PUR). Such foams can be shaped relatively easily in molds, to form different shapes of padding for different vehicle seat elements, for example such as the seating portion and the backrest.

Comparative fasteners may be inserted into the mold which are then overmolded. These fasteners are used, in particular, to attach a cover to the padding by clipping it onto the inserted fasteners.

Comparative polyurethane foam padding is satisfactory, but can retain moisture, particularly in humid conditions. This can cause discomfort for an occupant of a vehicle seat which has an element comprising such padding.

Furthermore, comparative polyurethane foam is made by mixing polyols with isocyanates as well as other additives. The chemical reaction involved emits CO₂ to form a foam, the emitted CO₂ contributing to global warming.

Furthermore, polyurethane foam is not recyclable. Therefore, at the end of its life, the seats are dismantled and sorted in order to separate out the various recyclable materials and extract the non-recyclable elements. The recyclable elements are then ground to form a new raw material, while the non-recyclable elements are, for example, landfilled, or if possible burned to generate energy.

However, a comparative padding is formed of a 3d entanglement of continuous fibers, arranged irregularly to form loops which are welded together. This padding is breathable and is less expensive to manufacture in terms of CO₂. The comparative fasteners used as inserts in polyurethane foam padding are not compatible with this 3D entanglement of continuous fibers.

Densification and stiffening of local areas of the 3D entanglement may allow attaching a cover to the padding, according to various techniques.

According to the findings, there is a need for other fastening systems suitable for attaching a cover to a padding, and in particular to a padding formed of a 3D entanglement of continuous fibers.

The present disclosure improves the situation.

A padding system is proposed comprising:

a padding comprising a groove on a surface of the padding intended to receive an occupant, a hole extending along an axis and traversing the padding from a bottom wall of the groove,

a fastening device integral to the padding, configured to provide the attachment of a cover to the padding, the fastening device comprising:

a fastening part, in particular a clip-on part, comprising a portion, in particular an elastically deformable portion, configured to allow attaching the cover, the fastening part being retained so as to project into the groove,

a base part extending under the fastening part into the hole,

at least one attachment part connected to the base part, comprising a rod traversing the padding at a distance from the hole and a stop collar projecting from the bottom wall of the groove, the stop collar being obtained by an operation of melting material from a free end of the rod.

The fastening device is thus inserted into the padding before the melting operation is performed, such that the padding system comprises a fastening device made integral to the padding by means of the abutment formed by the collar of the attachment part.

The features set forth in the following paragraphs may optionally be implemented, independently of one another or in combination with one another:

The stop collar may be welded to the padding. In this case, the melting operation includes a welding operation. The stop collar is then thus obtained by melting material from a free end of the rod, causing the stop collar to be welded to the bottom wall of the groove in the padding.

Alternatively, the stop collar is not welded to the padding, the melting operation having been carried out solely in order to create the stop collar in abutment against the bottom wall of the groove. In this case, the stop collar only forms a retaining element which functions via the abutment.

The stop collar is, for example, obtained by ultrasonic fusion. In this case, the melting operation consists of using at least one sonotrode and an anvil to melt the end of the rod in order to obtain the stop collar, while holding the fastening device in place in the padding.

The rod preferably extends substantially perpendicularly to the bottom wall of the groove. It passes through all or part of the thickness of the padding.

In some examples, the rod has a cylindrical shape. The cylindrical rod is preferably hollow, at least at the free end of the rod.

In other examples, the rod has a blade shape. In this case, the padding preferably comprises a through-slot, the blade extending into the slot.

The blade may extend transversely to an axis of the groove, in particular perpendicularly to it.

Alternatively, the blade may extend along the axis of the groove.

Regardless of its shape, the rod may act as a stabilizer for the fastening device in a positioning that allows for easy attachment of the cover, in particular clipping it on. In particular, when there are several fastening devices, they are preferably aligned along the longitudinal axis of the groove so as to facilitate attaching the cover.

The fastening device may comprise two attachment parts extending one on either side of the hole, preferably symmetrically to each other, in particular with an alignment between the rods and the hole along the axis of the groove.

The hole may comprise a first passage section in an upper first portion of the hole, and at least one second passage section, as an extension along the axis of the hole, in a lower second portion of the hole. The at least one second passage section may be wider than the first passage section, forming at least one shoulder between the upper first portion and the lower second portion of the hole. In this case, the fastening device may extend essentially at the upper first portion of the hole.

The fastening device may comprise at least one connecting part configured to connect the base portion and the at least one attachment part. In the case where the hole comprises a first and a second passage section, then the connecting part may extend into the second passage section, in particular at the shoulder.

The padding may comprise a 3d entanglement of continuous thermoplastic fibers arranged irregularly to form loops which are welded together. In this case, the groove and the hole may be formed in the 3d entanglement of fibers. In the case where the rod forms a blade, then the slot made in the padding is preferably formed in the 3d entanglement of fibers.

This thus provides padding made of a material other than polyurethane foam. This padding material is advantageously a recyclable plastic and its production generates fewer CO₂ emissions than the production of polyurethane foam, thus reducing the ecological impact of the seating element comprising this padding. In addition to the environmental benefits, the padding may be significantly lighter than similar polyurethane foam upholstery. Furthermore, the padding material may be more breathable, allowing better passage of air and any moisture through the padding.

The material of the padding and the material of the fastening device may be the same material, or two different materials with similar physicochemical properties, in particular the same chemical composition. This may allow the padding and the fastening device to be recycled simultaneously without separating them. Alternatively, the material of the padding and the material of the fastening device may be incompatible materials. In such case, solutions may be implemented to separate the incompatible materials for recycling purposes.

In some examples, the material of the padding and the material of the fastening device may be a thermoplastic polymer in which the main-chain repeating unit comprises the ester functional group and optionally the ether functional group, in particular a thermoplastic elastomer in which the main-chain repeating unit comprises the ester functional group and optionally the ether functional group.

According to another aspect, in combination with all or part of the above, a vehicle seat assembly is provided that comprises a padding system as defined above and a cover which covers all or part of the padding and is fixed to the padding by a fastening element, in particular a clip-on element, which interlocks, in particular elastically, with the fastening part of the fastening device.

According to another aspect, in combination with all or part of the above, a method of manufacturing a padding system as defined above is provided, comprising the following:

/A/ supplying a padding comprising a groove on a surface of the padding intended to receive an occupant, a hole extending along an axis (A) and traversing the padding from a bottom wall of the groove,

/B/ supplying a fastening device comprising:

a fastening part, in particular a clip-on part, comprising a portion, in particular an elastically deformable portion, configured to allow attaching the cover,

a base part extending under the fastening part,

at least one attachment part connected to the base part, comprising a rod which extends at a distance from the base part,

/C/ inserting the fastening device into the hole so that the fastening part is in position in the groove, projecting from the bottom wall of the groove with the base part extending into the hole, the rod traversing the padding at a distance from the hole, the free end of the rod projecting from the bottom wall of the groove,

/D/ melting material from a free end of the rod so as to create the stop collar projecting from the bottom wall of the groove.

Supplying the padding may comprise obtaining the padding by extruding a 3d entanglement of continuous thermoplastic fibers arranged irregularly to form loops which are welded together, and shaping the 3d entanglement by thermoforming in order to obtain the groove and the hole.

According to another aspect, in combination with all or part of the above, a method of recycling a vehicle seat assembly as defined above is provided, the material of the padding and of the fastening device being a thermoplastic polymer in which the main-chain repeating unit comprises the ester functional group and optionally the ether functional group, the method comprising:

optionally, separating the cover from the padding system,

grinding the padding and the fastening device attached to the padding, to produce granules,

using the granules to manufacture a plastic product based on a thermoplastic polymer in which the main-chain repeating unit comprises the ester functional group and optionally the ether functional group, in particular by molding or extrusion.

A padding system (1) comprising:

a padding (2) comprising a groove (4) on a surface (5) of the padding intended to receive an occupant, a hole (7) extending along an axis (A) and traversing the padding (2) from a bottom wall (6) of the groove,

a fastening device (3) integral to the padding (2), configured to provide the attachment of a cover (40) to the padding (2), the fastening device (3) comprising:

a fastening part (10) comprising a portion (11) configured to allow attaching the cover (40), the fastening part (10) being retained so as to project into the groove (4),

a base part (15) extending under the fastening part (10) into the hole (7),

at least one attachment part (20) connected to the base part (15), comprising a rod (21) traversing the padding (2) at a distance from the hole (7) and a stop collar (22) projecting from the bottom wall (6) of the groove, the stop collar (22) being obtained by an operation of melting material from a free end (23) of the rod (21).

1. A padding system comprising:
a padding comprising a groove on a surface of the padding configured to receive an occupant, a hole extending along an axis and traversing the padding from a bottom wall of the groove,
a fastening device integral to the padding, configured to provide the attachment of a cover to the padding, the fastening device comprising:
a fastening part comprising a portion configured to allow attaching the cover, the fastening part being retained so as to project into the groove,
a base part extending under the fastening part into the hole,
at least one attachment part connected to the base part, comprising a rod traversing the padding at a distance from the hole and a stop collar projecting from the bottom wall of the groove, the stop collar being obtained by an operation of melting material from a free end of the rod.

2. The padding system of claim 1, wherein the stop collar is welded to the padding.

3. The padding system of claim 2, wherein the stop collar is obtained by ultrasonic fusion.

4. The padding system of claim 1, wherein the rod has a cylindrical shape, which is hollow at least at the free end of the rod.

5. The padding system of claim 1, wherein the rod has a blade shape, the padding comprising a through-slot, the blade extending into the slot, the blade extending transversely to an axis of the groove.

6. The padding system of claim 1, wherein the rod has a blade shape, the padding comprising a through-slot, the blade extending into the slot, the blade extending along the axis of the groove.

7. The padding system of claim 1, wherein the fastening device comprises two attachment parts extending one on either side of the hole, preferably symmetrically to each other, in particular with an alignment between the rods and the hole along the axis of the groove.

8. The padding system of claim 1, wherein the padding comprises a 3d entanglement of continuous thermoplastic fibers arranged irregularly to form loops which are welded together, the groove and the hole being formed in the 3d entanglement of fibers.

9. A vehicle seat assembly comprising a padding system according to claim 1, and a cover which covers all or part of the padding and is fixed to the padding by a fastening element which interlocks, in particular elastically, with the fastening part of the fastening device.

10. A method of manufacturing a padding system according claim 8, comprising:
/A/ supplying a padding comprising a groove on a surface of the padding intended to receive an occupant, a hole extending along an axis and traversing the padding from a bottom wall of the groove,
/B/ supplying a fastening device comprising:
a fastening part comprising a portion configured to allow attaching the cover,
a base part extending under the fastening part,
at least one attachment part connected to the base part, comprising a rod which extends at a distance from the base part,
/C/ inserting the fastening device into the hole so that the fastening part is in position in the groove, projecting from the bottom wall of the groove with the base part extending into the hole, the rod traversing the padding at a distance from the hole, the free end of the rod projecting from the bottom wall of the groove,
/D/ melting material from a free end of the rod so as to create the stop collar projecting from the bottom wall of the groove.

11. The method of claim 10, wherein the supplying of the padding comprises obtaining the padding by extruding a 3d entanglement of continuous thermoplastic fibers arranged irregularly to form loops which are welded together, and shaping the 3d entanglement by thermoforming in order to obtain the groove and the hole.

12. A method of recycling a vehicle seat assembly according to claim 9, wherein the material of the padding and of the fastening device is a thermoplastic polymer in which the main-chain repeating unit comprises the ester functional group and optionally the ether functional group, the method comprising:
optionally, separating the cover from the padding system,
grinding the padding and the fastening device attached to the padding, to produce granules,
using the granules to manufacture a plastic product based on a thermoplastic polymer in which the main-chain repeating unit comprises the ester functional group and optionally the ether functional group, in particular by molding or extrusion.
